(19) United States
(12) Patent Application Publication
(10) Pub. No.: US 2005/0276270 A1
(43) Pub. Date: Dec. 15, 2005

(54) System, method, and device for recording rich media data

(76) Inventors: Rimas Buinevicius, Madison, WI (US); James Dias, Madison, WI (US)

Correspondence Address: FOLEY & LARDNER, 150 EAST GILMAN STREET, P.O. BOX 1497, MADISON, WI, 53701-1497, US

(21) Appl. No.: 10/855,782

(22) Filed: May 27, 2004

(51) Int. Cl. H04L 1/00

(52) U.S. Cl. 370/395.5

(57) ABSTRACT

An automated system, device, computer program product, and method of selectively recording media data generated during a round-table meeting is provided. In the system, one or more media devices capture media data and generate three or more concurrent media inputs having various formats from the captured media data. One or more connection devices connect the one or more media devices to a recorder. The recorder receives the three or more concurrent media inputs, selects three or more of the received media inputs to record to a memory, encodes any of the selected three or more media inputs to form a media stream if the selected media input is not in a media stream format, and records the selected media streams to the memory. Additionally, the recorder may synchronize, index, and/or time stamp the selected three or more media streams before the media streams are recorded to the memory. The recorder further may enable one or more of the media devices for use by a consumer. The recorded media streams may be copied to other memories or to a network location and may be replayed later for review of the round-table meeting.

### FIELD OF THE INVENTION

The present invention relates to rich media recording systems. More particularly, the present invention relates to an automated system, device, method, and computer program product for selectively recording rich media data during a meeting.

### BACKGROUND OF THE INVENTION

A number of products have been developed to address the capture and recording of presentations. These products include: the StreamGenie Presenter product available from Pinnacle Systems, Inc. of Mountain View, Calif.; the CommuniCast 1000 product available from e-StudioLIVE of Tewksbury, Mass.; the WebLearner product available from Tegrity, Inc. of San Jose, Calif.; and the Mediasite Live product available from Sonic Foundry, Inc. of Madison, Wis., the assignee of the present application. U.S. patent Ser. No. 10/702,064 assigned to the assignee of the present application describes a rich media event production system and method including the capturing, indexing, and synchronizing of RGB-based graphic content.

These products, however, are directed to online videoconferencing where attendees worldwide attend the same presentation. These products are further directed to presentations. The focus during such a presentation is on a single presenter at a time even when there are multiple presenters in succession. Round-table meetings incorporate discussion among various meeting attendees and involve a rapidly changing, dynamic environment where the focus shifts from attendee to attendee around the table rather than to a single individual at the front of the room. Repeated viewing of these types of meetings, such as a design review meeting, are beneficial to both attendees and to others who were not able to attend the meeting.

What is desired, therefore, is a system and method for processing media data, in any number of formats, including the live interaction between attendees during a round-table meeting. What is further needed is an automated system and method of selectively recording media streams from a plurality of media capture devices. What is further needed is a system and method of providing electronic copies of the composite meeting materials to both meeting attendees and others. The system and method should further provide the capability to distribute the recorded materials in a format that is easy to replay and to archive for future review.

### SUMMARY OF THE INVENTION

An exemplary embodiment relates to a recording device. The device includes a connector, a memory, a processor, and an application. The connector connects to an interface to a media device and receives concurrent media inputs generated by the plurality of media devices. The processor couples to the memory and executes the application. The application comprises computer code configured to select three or more media inputs from the received concurrent media inputs to record to the memory, to encode any of the selected three or more media inputs to form a media stream if the selected media input is not in a media stream format, and to record the selected three or more media streams to the memory. The computer code further may be configured to:
enable at least one media device,
synchronize and index the selected three or more media streams before the selected three or more media streams are recorded to the memory,
time stamp the selected three or more media streams before the selected three or more media streams are recorded to the memory, and/or
replay the recorded media streams.

The memory includes, but is not limited to, any of a flash memory, a compact disc, a digital video disc, a Jaz™ disc, a Zip™ disc, a floppy disk, and/or a hard disk. The connector includes, but is not limited to, any of a Universal Serial Bus (USB) connector, a Small Computer System Interface (SCSI) connector, a IEEE 1394 connector, a Digital Video Interface (DVI) connector, a Video Graphics Array (VGA) connector, an IEEE 802.11 connector, a Bluetooth connector, an Ethernet connector, a telephone line connector, a coaxial cable connector, and/or an Integrated Device Electronics (IDE) connector. The interface includes, but is not limited to, any of a USB interface, a SCSI, an IEEE 1394 interface, a DVI, a VGA interface, an IEEE 802.11 interface, a Bluetooth interface, an Ethernet interface, a telephone line interface, a coaxial cable interface, and/or an IDE interface. The media device includes, but is not limited to, any of a video camera, a microphone, a digital camera, an electronic whiteboard, a personal computer, a document camera, and/or a projector. The device may further comprise a microphone, a video camera, a display, and/or a network connector.

Another exemplary embodiment relates to a recording system. The system includes a media device, an interface to each media device, a connector, a memory, a processor, and an application. The media device captures media data and generates concurrent media inputs from the captured media data. The connector connects to the interface to each media device and receives the concurrent media inputs generated by the media device. The processor couples to the memory and executes the application. The application comprises computer code configured to select three or more media inputs from the received concurrent media inputs to record to the memory, to encode any of the selected three or more media inputs to form a media stream if the selected media input is not in a media stream format, and to record the selected three or more media streams to the memory. The computer code further may be configured to:
enable at least one media device,
synchronize and index the selected three or more media streams before the selected three or more media streams are recorded to the memory,
time stamp the selected three or more media streams before the selected three or more media streams are recorded to the memory, and/or
replay the recorded media streams.

The memory includes, but is not limited to, any of a flash memory, a compact disc, a digital video disc, a Jaz™ disc, a Zip™ disc, a floppy disk, and/or a hard disk. The connector includes, but is not limited to, any of a Universal Serial Bus (USB) connector, a Small Computer System Interface (SCSI) connector, a IEEE 1394 connector, a Digital Video Interface (DVI) connector, a Video Graphics Array (VGA) connector, an IEEE 802.11 connector, a Bluetooth connector, an Ethernet connector, a telephone line connector, a coaxial cable connector, and/or an Integrated Device Electronics (IDE) connector. The interface includes, but is not limited to, any of a USB interface, a SCSI, an IEEE 1394 interface, a DVI, a VGA interface, an IEEE 802.11 interface, a Bluetooth interface, an Ethernet interface, a telephone line interface, a coaxial cable interface, and/or an IDE interface. The media device include, but is not limited to, any of a video camera, a microphone, a digital camera, an electronic whiteboard, a personal computer, a document camera, and/or a projector.

The system may further comprise a display, a network connector, and/or an electronic payment system. The electronic payment system validates access to the system and sends a validation signal to the processor if the access is validated.

Yet another exemplary embodiment relates to a method of recording media data. The method includes capturing media data by a media device connected to a connection device, generating concurrent media inputs by the media device from the captured media data, receiving the generated concurrent media inputs through the connection device at a recorder, selecting three or more media inputs from the received concurrent media inputs using an application executing at the recorder, encoding any of the selected three or more media inputs to form a media stream if the selected media input is not in a media stream format, and recording the selected three or more media streams to a memory using the application.

The method may further include:
enabling at least one media device from the recorder using the application,
synchronizing and indexing the selected three or more media streams at the recorder using the application before the selected three or more media streams are recorded to the memory,
time stamping the selected three or more media streams at the recorder using the application before the selected three or more media streams are recorded to the memory,
replaying the recorded media streams,
validating user access to at least one media device using an electronic payment system connected to at least one connection device;
sending a validation signal from the electronic payment system to the recorder if the user access is validated; and/or
receiving the validation signal at the recorder if the validation signal is sent.

The memory includes, but is not limited to, any of a flash memory, a compact disc, a digital video disc, a Jaz™ disc, a Zip™ disc, a floppy disk, and/or a hard disk. The connection device includes a connector. The connector includes, but is not limited to, any of a Universal Serial Bus (USB) connector, a Small Computer System Interface (SCSI) connector, a IEEE 1394 connector, a Digital Video Interface (DVI) connector, a Video Graphics Array (VGA) connector, an IEEE 802.11 connector, a Bluetooth connector, an Ethernet interface, a telephone line interface, a coaxial cable interface, and/or an Integrated Device Electronics (IDE) connector. The media device includes, but is not limited to, any of a video camera, a microphone, a digital camera, an electronic whiteboard, a personal computer, a document camera, and/or a projector.

Yet another exemplary embodiment relates to a computer program product for recording media data. The computer program product comprises computer code. The computer code is configured to select three or more media inputs received from a media device to record to a memory, to encode any of the selected three or more media inputs to form a media stream if the selected media input is not in a media stream format, and to record the selected three or more media streams to the memory. The computer code further may be configured to:
enable at least one media device,
synchronize and index the selected three or more media streams before the selected three or more media streams are recorded to the memory,
time stamp the selected three or more media streams before the selected three or more media streams are recorded to the memory, and/or
replay the recorded media streams.

The memory includes, but is not limited to, any of a flash memory, a compact disc, a digital video disc, a Jaz™ disc, a Zip™ disc, a floppy disk, and/or a hard disk. The media device includes, but is not limited to, any of a video camera, a microphone, a digital camera, an electronic whiteboard, a personal computer, a document camera, and/or a projector. At least one of the media devices may be enabled using an electronic payment system.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is a diagrammatical representation of a media recording device in accordance with an exemplary embodiment.

FIG. 2 shows sample connectors for use in a media recording system in accordance with the invention.

FIG. 3 shows sample components of the media recording system in accordance with the invention.

FIG. 4 is a diagrammatical representation of a media recording system in accordance with an exemplary embodiment.

FIG. 5 is a flow diagram of operations performed by a media recording system in accordance with an exemplary embodiment.

FIG. 6 is a diagrammatic representation of a first use case of the media recording system.

FIG. 7 is a diagrammatic representation of a second use case of the media recording system.

FIG. 8 is a diagrammatic representation of a third use case of the media recording system.

### DETAILED DESCRIPTION OF EXEMPLARY EMBODIMENTS

Exemplary embodiments described herein provide a system and method of recording digital media data to permit subsequent access to and review of a meeting. The exemplary embodiments may be employed for the automatic processing of large amounts of media data to be recorded for future replay of the meeting and distribution of the meeting content for example using e-mail, the Internet, or a Local or a Wide Area Network.

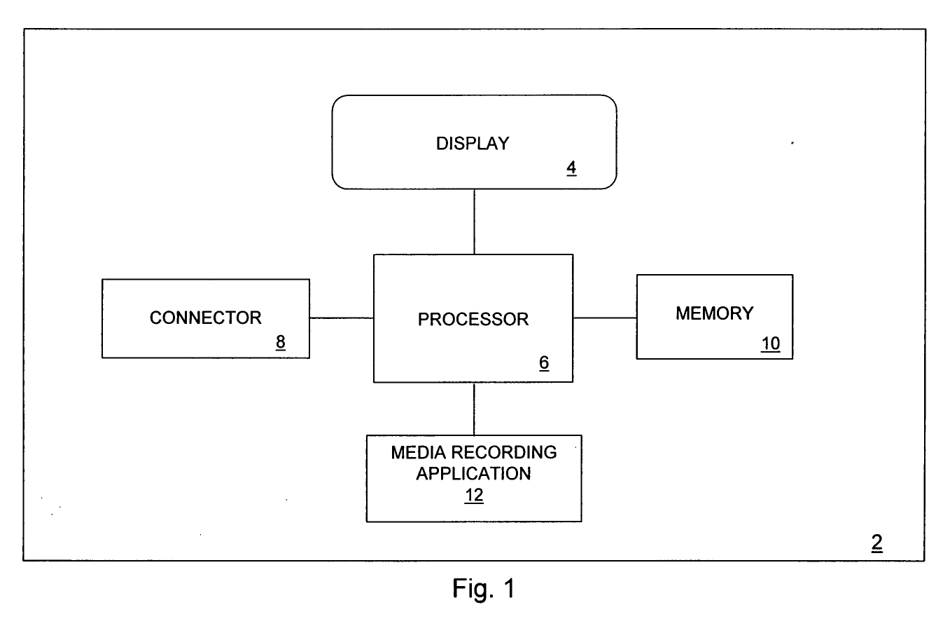

FIG. 1 illustrates a media recording device 2 used to record audio, visual, and various graphical data generated by media devices during a round-table meeting. In an exemplary embodiment, the media recording device 2 includes, but is not limited to, a display 4, a processor 6, a connector 8, a memory 10, and a media recording application 12. The display 4 presents information to the user including a user interface created by executing applications. The display 4 can be a thin film transistor (TFT) display, a light emitting diode (LED) display, a Liquid Crystal Display (LCD), a Cathode Ray Tube (CRT) display, or any of a variety of different displays known to those skilled in the art. The display can be any size. No display is required as part of the media recording device 2.

A variety of video standards define the resolution and colors for displays 4. Video Graphics Array (VGA) is a common graphical display system for Personal Computers (PCs). VGA uses analog signals rather than digital signals. Additional standards, SVGA, XGA, SXGA, and UXGA, have been developed that offer greater resolution and additional colors. Digital Video Interface (DVI) is a specification created to support analog and digital displays with a single connector. There are three different DVI configurations: DVI-A (analog), designed for analog signals; DVI-D (digital), designed for digital signals; and DVI-I (integrated), designed for both analog and digital signals. The DVI format is designed to optimize the quality of a PC's image on a flat panel LCD.

Using a DVI connector and interface, a digital signal that is sent to an analog display is converted into an analog signal. If the monitor is a digital display, such as a flat panel display, no conversion is necessary. Internally, the video image generated by a PC is in digital format, but the video card converts the digital signal into an RGB (Red-Green-Blue) analog signal that is output to the display. A CRT display uses the analog signal directly because CRT displays use analog circuits. However, an LCD must convert the information back into a digital format. DVI eliminates the double conversion between an analog and a digital signal format.

The processor 6 executes instructions from the media recording application 12 in addition to other instructions contained within the processor 6. In an exemplary embodiment, a user may execute the media recording application 12 by selecting the application for launch. In an alternative embodiment, the media recording application 12 executes automatically when the media recording device 2 is powered on. The media recording device 2 may have a plurality of processors 6.

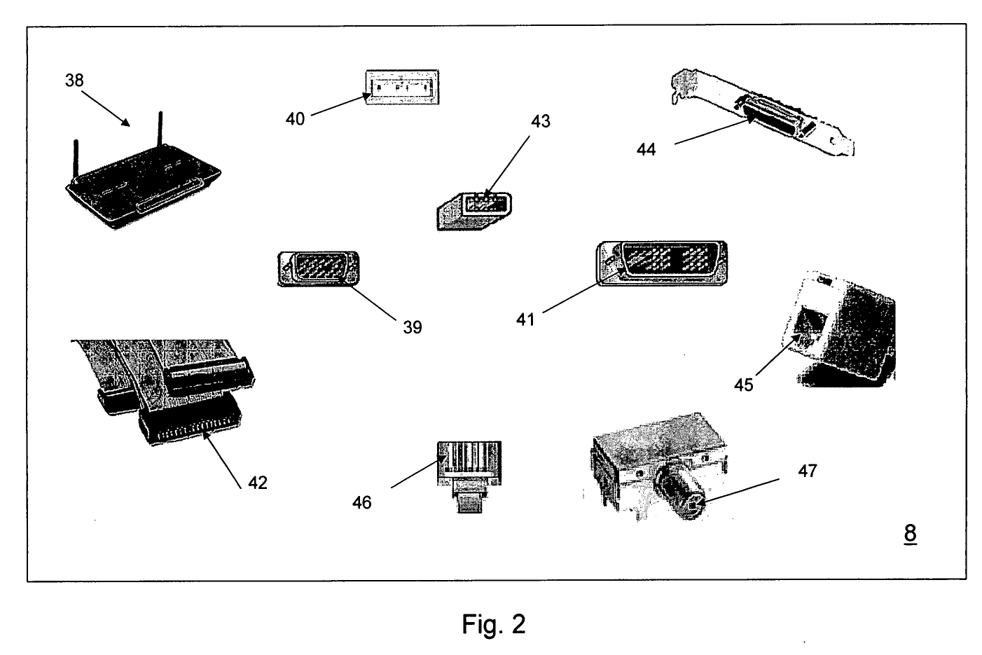

Connectors 8 connect the media recording device 2 to a plurality of media devices and/or to a network. The connectors 8 also may connect the media recording device 2 to a memory 10. The media recording device 2 may have a plurality of connectors 8. The plurality of connectors 8 may be of different types. Example connector types 8 include, but are not limited to, a Universal Serial Bus (USB) connector 40, a Small Computer System Interface (SCSI) connector 44, an IEEE 1394 connector 43, a DVI connector 41, a VGA connector 39, an IEEE 802.11 wireless connector 38, a Bluetooth wireless connector 38, an Integrated Device Electronics (IDE) connector 42, a 10 or 100 Base-T Ethernet (Ethernet) connector 46, a telephone line connector 45, a coaxial cable connector 47, and the like, as shown in FIG. 2. A network connector provides access to a local area network or a wide area network such as the Internet. Network connectors include, but are not limited to, a USB connector 40, a SCSI connector 44, an IEEE 1394 connector 43, an IEEE 802.11 wireless connector 38, an IDE connector 42, an Ethernet connector 46, a telephone line connector 45, a coaxial cable connector 47, and the like. The media recording device 2 may include a network connector to receive and to transmit data over a network.

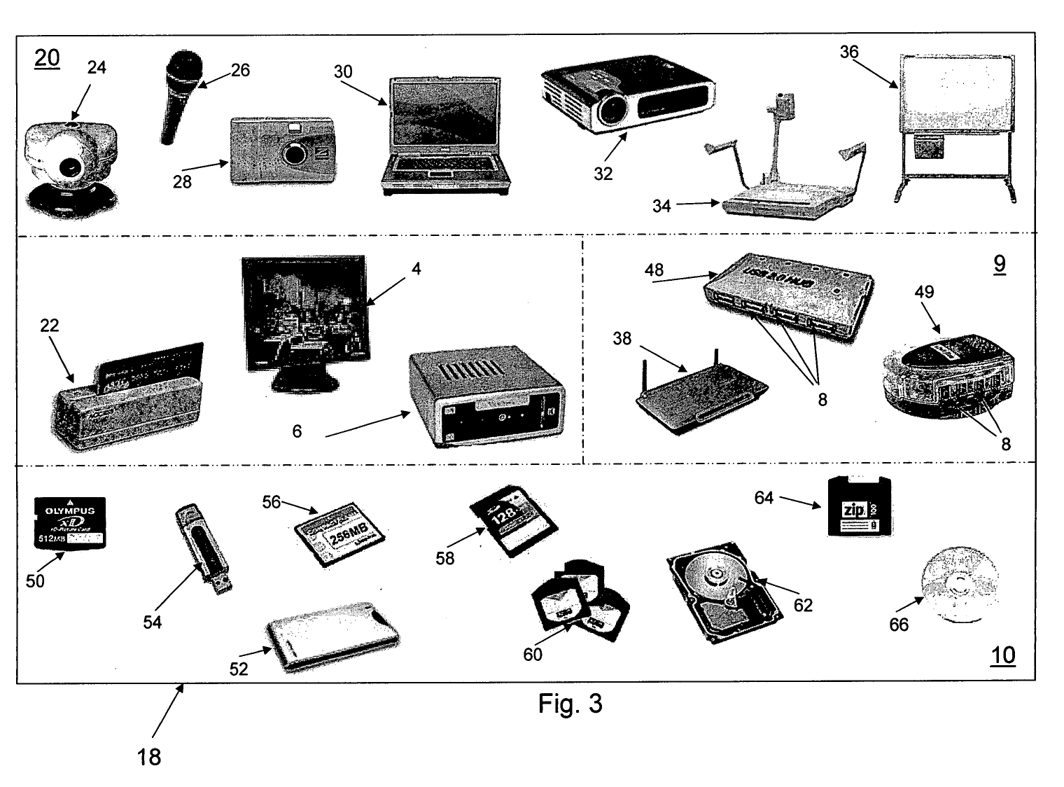

The plurality of connectors 8 may be incorporated into a connection device 9 as shown in FIG. 3. For example, USB hub 48 contains four USB connectors and IEEE 1394 hub 49 contains eight IEEE 1394 connectors. A plurality of connection devices may be connected to each other to provide still more connectors. Typically, but not always, the plurality of connection devices are daisy-chained together such that one input or downstream connector 8 from each connection device connects to the output (also known as the upstream or root) connector of the other connection device to allow a common connection to all of the media devices. For example, commercially available USB hubs currently provide up to 127 connector ports for connecting peripheral devices. The connectors provide various transmit speeds that continue to increase as the connectors evolve. For example, a connector supporting the USB 2.0 standard supports a transfer rate of up to 480 Mega-bits-per-second as compared to a connector supporting the USB 1.0 standard that supports a transfer rate of up to 12 Mega-bits-per-second.

The connectors provide an interface for connecting multiple peripherals including media devices 22 and memories 10, as shown in FIG. 3, allowing the flow of data into and out of each interface. Example interfaces correspond to the connector types 8 and include, but are not limited to, a USB interface, a SCSI interface, an IEEE 1394 interface, a DVI interface, a VGA interface, an IEEE 802.11 wireless interface, a Bluetooth wireless interface, an IDE interface, an Ethernet interface, a telephone line interface, a coaxial cable interface, and the like.

Launching an application generally requires retrieving the executable form of the application from a permanent memory device and copying the executable to a temporary memory device. The temporary memory device is generally some form of random access memory (RAM). The data in RAM is volatile meaning that it remains only as long as the computer is turned on. When the computer is turned off, RAM loses its data. Read only memory (ROM) refers to memory used to store programs that boot the computer and perform diagnostics. The values stored in ROM are always there, whether the power is on or not. For this reason, it is called non-volatile memory. ROM is most commonly used to store system-level programs that must be available to the computer at all times. Flash memory is a type of constantly-powered nonvolatile memory that can be erased and reprogrammed in units of memory called blocks. Flash memory is a variation of electrically erasable programmable read-only memory (EEPROM) which, unlike flash memory, is erased and rewritten at the byte level, making EEPROM slower to update.

A media recording system 18, as shown in FIG. 3, includes, but is not limited to, the plurality of media devices 20, an interface to each of the plurality of media devices 20, the connector 8, the memory 10, the processor 6, the media recording application 12, and an electronic payment system 22. The plurality of media devices 20 capture media data and generate media inputs from the captured media data. The connector 8 connects to an interface to the plurality of media devices 20 and to the processor 6. The connector 8 also may be utilized to connect the media recording system 18 to a network. The processor 6 receives the media inputs generated by the plurality of media devices through the various connectors 8. The media inputs may be received in a variety of formats. The processor 6 may encode the media inputs converting the media input to a different format that generally is compressed to form a media stream. If the media input, however, is already in a suitable media stream format, no additional encoding of the media input is performed. The processor 6 selectively records the media streams on one or more memories 10.

Information may be recorded to a wide variety of memory devices that hold various amounts of information and vary in physical size. As shown in FIG. 3, the memory 10 includes, but is not limited to, media such as a flash memory 50-58, a compact disc 66, a digital video disc, a Jaz disc 60, a Zip disc 64, a floppy disk, and a hard disk 62. The memory 10 may use a variety of different technologies for storing and for playing back data recorded thereon. Connectors 8 connect to the memory 10 allowing the transmission of data to the memory 10 from other devices as known to those skilled in the art.

As shown in FIG. 3, the media recording system 18 may include a wide variety of media devices 20 for capturing the meeting materials as well as the live meeting interaction. The media devices include, but are not limited to, a video camera 24, a microphone 26, a digital camera 28, an electronic whiteboard 36, a PC 30, a document camera 34, and/or a projector 32. The system 18 may include a plurality of each type of media device. For example, multiple PCs 32 may be included in the media recording system 18.

The media devices 20 capture media data and generate digital and/or analog media inputs to be recorded by the media recording application 12. Each media input may have different characteristics for example different compression levels or no compression, different data rates, different formats, etc. For example, a typical digital camera records still images in the JPEG format named after the Joint Photographic Experts Group. The JPEG format provides a format for compressing the digital image data to reduce the size of the digital image file created. There are, however, other possible formats including the Tag Image File Format (TIFF) which is uncompressed and the CCD RAW format in which the image data is stored directly from the image sensor without first processing it. Similarly, video data may be input to the media recording application 12, for example, in RGB format. The media recording application 12 may convert the RGB formatted media input to a more suitable format through encoding to create a media stream. Conversely, the DVI-I formatted media input may already be in a suitable media stream format, and thus, not require any additional encoding.

Use of system 18 in a publicly accessible location may be supported by providing a capability to charge a user on a per use basis using the electronic payment system 22. For example, as shown in FIG. 3, the electronic payment system 22 may comprise a magnetic card reader. Example magnetic card readers include a credit card reader, a debit card reader, a magnetic strip reader, and/or a smart card reader. The electronic system may accept currency, magnetic cards, smart cards, credit cards, debit cards, or any other value storing medium that is capable of storing and of communicating qualification data to enable the media recording system 18.

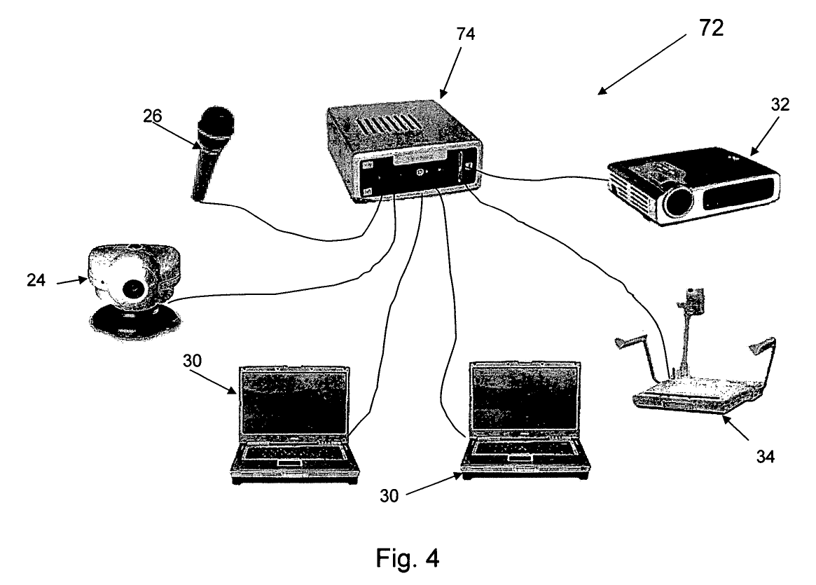

FIG. 4 shows a diagrammatic representation of an exemplary media recording system 72. The media recording system includes the video camera 24, the microphone 26, a plurality of PCs 30, the document camera 30, a media recording device 74, and the projector 32. The video camera 24, the microphone 26, the plurality of PCs 30, and the document camera 30 generate media inputs that are transmitted either over cable or wirelessly to the media recording device 74. The transmission media depend upon the interface at each of the media devices and may be different from device to device. The media recording device 74 receives the media inputs through the connector 8, encodes media inputs that are not in a media stream format, and selectively records the media streams to the memory 10.

The media recording device 74 may comprise a single device that includes the processor 6, the plurality of connectors 8, the memory 10, and the media recording application 12 described with respect to FIG. 1. In alternative embodiments, the media recording device may include the display 4 as shown in FIG. 1. The display may be integrated into the media recording device or may be a separate stand-alone entity connected to the media recording device. In alternative embodiments, the functionality integrated into the media recording device 74 may be distributed across separate entities. For example, connection devices external to the media recording device may connect to the media devices. A single transmission medium may then connect the connection devices to a connector integrated into the media recording device. Similarly, the memory 10 may be located external to the media recording device and connect to the media recording device through a connector.

An application provides computing devices with the capability to perform a wide variety of tasks including drafting documents, communicating with others, preparing presentations, delivering presentation, locating information, recording media streams, etc. The media recording application 12 is an organized set of instructions that, when executed, cause the media recording device 2 to behave in a predetermined manner. The instructions may be written using one or more programming languages. The instructions may further be written in scripting languages that do not require assembly and compilation prior to execution. The term “execution” is the process of running an application or the carrying out of the operation called for by an instruction. The processor 6 executes an instruction, meaning that it performs the operations called for by that instruction. The media recording application 12 may be written in a variety of computer languages including, but not limited to high level languages, scripting languages, assembly languages, etc. Additionally, the operations of the media recording application 12 may be carried out by a special purpose computer, logic circuits, or hardware circuits. Thus, the media recording application 12 may be implemented in hardware, firmware, software, or any combination of these methods.

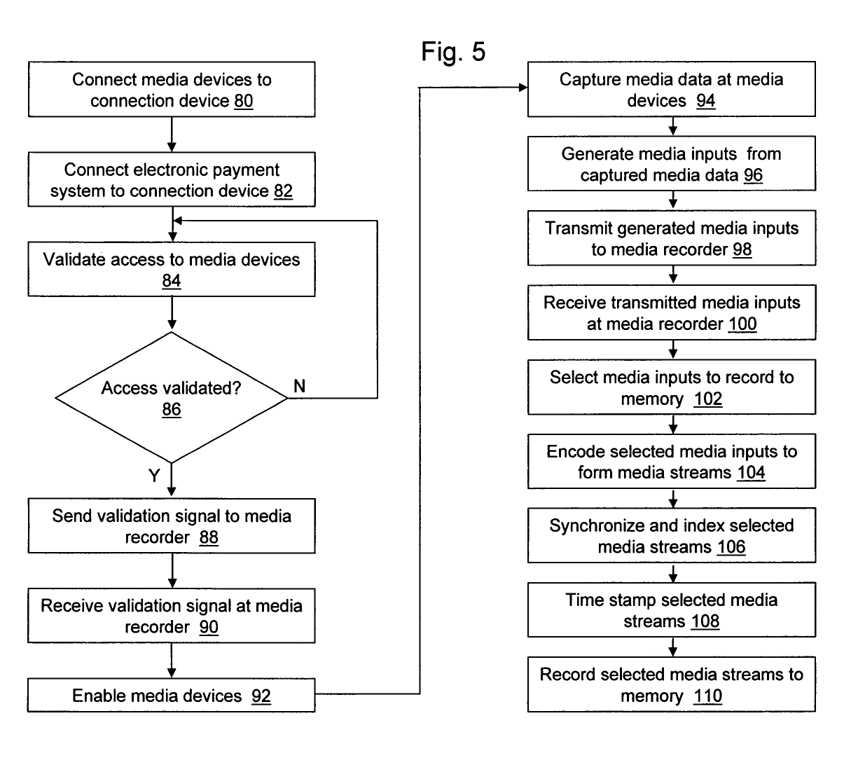

The media recording application 12 executed from the media recording device 2 enables the media recording system 18 for use by the user. As shown in FIG. 5, the desired media devices 20 are connected to a connection device at operation 80. The connection device may be integrated into the media recording device 2 or may be a separate entity connected to the media recording device 2. In an exemplary embodiment, at operation 82, the electronic payment system 22 is connected to the connection device that may be the same or different from the connection device described at operation 80. Access to the media recording system 18 is validated at operation 84, in an exemplary embodiment. Validation, for example, may comprise swiping a credit card through a magnetic card reader. The information read from the card is sent to a credit card verification center that returns a signal either accepting or not accepting the transaction. The test at operation 86 determines if the access was validated, for example by receiving a transaction accepted signal from a credit card verification center. If the access is not validated, another attempt to validate access to the media recording system 18 is performed. If access is validated, the validation signal is transmitted to the media recording device 2 at operation 88. At operation 90, the validation signal is received at the media recording device 2. The media recording device 2 enables the media devices 20 for use at operation 92. In an alternative embodiment, no validation is required to access the media recording system 18, and the media devices are enabled automatically after connection to the connection device.

At operation 94, media data is captured by the media devices. For example, the microphone 26 captures the attendee discussion in either an analog or digital format. Concurrent media inputs are generated from the captured media data at operation 96. At operation 98, the concurrently generated media inputs are transmitted through the interface at the media device to the connector 8 at the media recording device 2. The media recording device 2 receives the media inputs at operation 100. The media recording application 12 selects the media inputs to record to the memory at operation 102. For example, the media recording application 12 may utilize change detection algorithms to determine if the media input has changed. If the media input from a media device has not changed, the media input from that device is not recorded.

More sophisticated algorithms may identify media inputs for recording based on an amount of change or a type of change. For example, the voice input from the microphone is preferably recorded in its entirety because it changes constantly unless the room is silent. Conversely, the graphical data input from the document camera 34 may change only intermittently when a new chart is placed on the device for display. Similarly, the PC may be recorded only intermittently depending upon the application used. If a simulation is executing, the media recording device 2 may record the entire extent of the media input from the PC. However, if a PowerPoint presentation is executing, the media input from the PC may change only when a new slide is displayed. As a result, the media input from the PC is selectively recorded only when a new slide is displayed. By automatically determining the media inputs to display, all media devices can be connected to the media recording device 2 at the outset of the meeting. The meeting is not interrupted by changing the media devices that are connected to the media recording device 2 as the meeting progresses and the focus shifts from one attendee to another and from one presentation device to another. At the same time, much less memory and processor time is required to record the content of the entire meeting.

In an exemplary embodiment, the media recording application 12 may encode one or more of the selected media inputs at operation 104. The media recoding application 12 forms a media stream from the selected media input through encoding of the media input if the selected media input is not in a media stream format. At operation 106, the selected media streams are synchronized and indexed for proper simultaneous replay of the media streams. For example, by synchronizing and indexing the media streams, the video and audio are properly aligned. The selected media streams may be time stamped at operation 108. Time stamping the files allows a user replaying the media streams to step forward in time to more easily locate information of significance to the user. At operation 110, the media streams that may be encoded, synchronized, indexed, and/or time stamped are recorded to the memory. The recorded media streams may be recorded to and/or copied to additional memories or to a network.

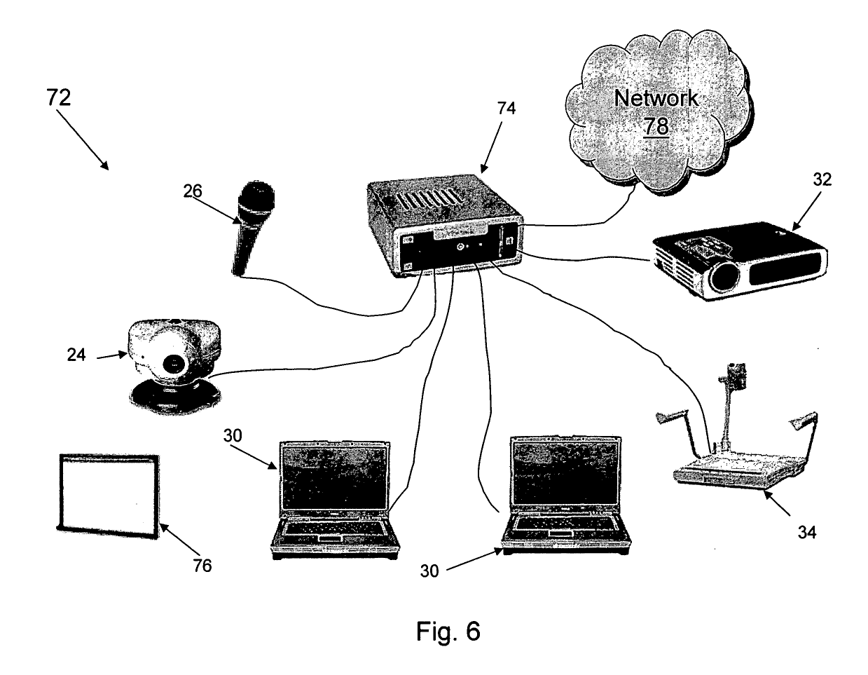

FIG. 6 illustrates a first example use case for a media recording system in accordance with the present invention. The media recording system 72 can be used by six attendees of a design review meeting, for example. Three meeting attendees have prepared materials for discussion. Two of the meeting attendees present their materials using their respective laptops 30. The third meeting attendee presents their materials using the document camera 34.

The media recording device 74 is connected to a network 78. A whiteboard 76 is not electronically connected to the media recording system 72. The video camera 24, however, is situated to capture information written on the whiteboard 76 during the round-table meeting. The video camera 24 is connected to the media recording device 74 through a connector integrated into the media recording device 74. The microphone 26 captures the discussion during the meeting and is connected to the media recording device 74 through a connector integrated into the media recording device 74. The laptops 30 are connected to the media recording device 74 through a connector integrated into the media recording device 74. The document camera 34 connects to the media recording device 74 through a connector integrated into the media recording device 74. A projector 32 is connected to the media recording device 74 through a connector integrated into the media recording device 74. The projector 32 receives the media streams recorded by the media recording device 74 and displays the received media streams so that all meeting attendees can view the meeting materials. In the exemplary embodiment of FIG. 6, the media recording device 74 includes the processor 6, the plurality of connectors 8, the memory 10, and the media recording application 12 described with respect to FIG. 1 integrated into a single device.

Before the meeting begins, the devices are connected to the media recording device 74 using the appropriate connectors 8 and powered on. The media recording device 74 also is powered on. The media recording device 74 receives the media inputs captured and generated by the media devices 24, 26, 30, and 34. The media recording application 12 initially records all of the media inputs as media streams. However, the media recording application 12 determines that only the media inputs from the microphone 26 and from the first laptop 30 are changing. Thus, shortly after initiation of the meeting, only two media streams are recorded to the memory 10 integrated into the media recording device 74. The duration of recording all media streams after initiation of the meeting may depend on the change detection algorithm used and the settings used. As the meeting progresses, the change detection algorithm re-initiates the recording of the media inputs from the video camera 24, the second laptop 30, and the document camera 34 as the devices are used. At the completion of the meeting, the media devices may be powered off and disconnected from the media recording device 74. The media streams recorded to the memory 10 may be accessed from the network 78. The media streams may further be copied to other memories 10, e-mailed to others, made available using the Internet, etc. The media streams may then be replayed by others unable to attend the meeting or by meeting attendees for review of the meeting content.

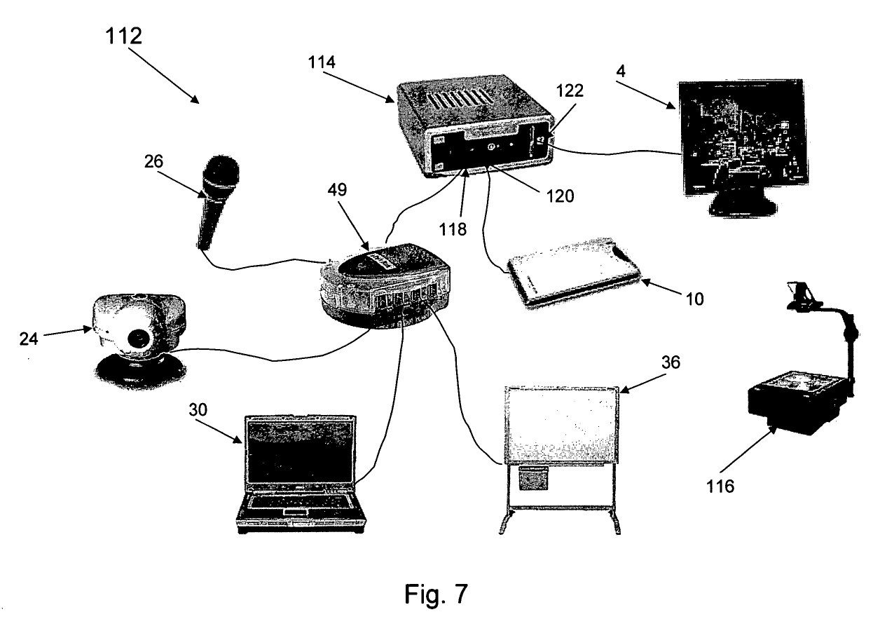

FIG. 7 illustrates a second example use case for a media recording system in accordance with the present invention. The media recording system 112 includes the video camera 24, the microphone 26, the laptop 30, and the electronic whiteboard 36 described with respect to FIG. 3 to capture media data and to generate media inputs from the captured media data. The system 112 additionally includes the IEEE 1394 hub 49, a media recording device 114, the memory 10, the display 4, and an overhead projector 116. The media devices 24, 26, 30, and 36 connect to the hub 49 that is external to the media recording device 114. The media recording device 114 connects to the hub 49 at an input connector 118 integrated into media recording device 114 to receive media inputs. The input connector 118 may comprise a IEEE 1394 connector. Multiple input connectors 118 may be integrated into media recording device 114.

The media recording device includes the processor 6 and the media recording application 12 of FIG. 1. The memory 10 comprises a USB hard drive that connects to the media recording device 114 through an output connector 120. The output connector 120 may comprise a USB connector. The media recording device 114 may include multiple output connectors 120. The display 4 connects to the media recording device at a video connector 122 that may comprise a DVI-I connector. The overhead projector 116 displays transparencies and is not electronically connected to the media recording device 114. The video camera 24, however, is situated to capture information displayed by the overhead projector 116 during the round-table meeting.

The round-table meeting utilizing the media recording system 112 is a new product brain storming session that includes four meeting attendees. One meeting attendee has presentation materials concerning current products stored on the laptop 30. A second meeting attendee has prepared transparencies with new product ideas to initiate the new product brain storming session. The meeting attendees plan to brainstorm using the electronic whiteboard 36.

Before the meeting begins, the media devices 24, 26, 30, and 36 are connected to the IEEE 1394 hub 49 using IEEE 1394 connectors and powered on. The media recording device 114, connected to the IEEE 1394 hub 49 through the input connector 118, is powered on. The memory 10 is connected to the output connector 120. The display 4, connected to the video connector 122, is powered on. The media recording device 114 receives the media inputs captured and generated by the media devices 24, 26, 30, and 36. The media recording application 12 initially records all of the media inputs in an appropriate streaming format. However, the media recording application 12 determines that only the media inputs from the microphone 26 and from the laptop 30 are changing initially. Thus, shortly after initiation of the meeting, only two media streams are recorded to the memory 10. The duration of recording of all media streams after initiation of the meeting may depend on the change detection algorithm used and the settings used. As the meeting progresses, the change detection algorithm re-initiates the recording of the media input from the video camera 24 when the second meeting attendee uses the overhead projector 116 to present the initial new product ideas. As meeting attendees use the electronic whiteboard 36, the media recording device 114 automatically begins to record the media input from the electronic whiteboard 36. At the completion of the meeting, the memory 10 may be removed from the media recording system 112. The memory 10 may be connected to another compatible device including a PC connected to a network. The media streams may further be copied to other memories 10, e-mailed to others, made available using the Internet, etc. The media streams may then be replayed by others unable to attend the meeting or by meeting attendees for review of the meeting content.

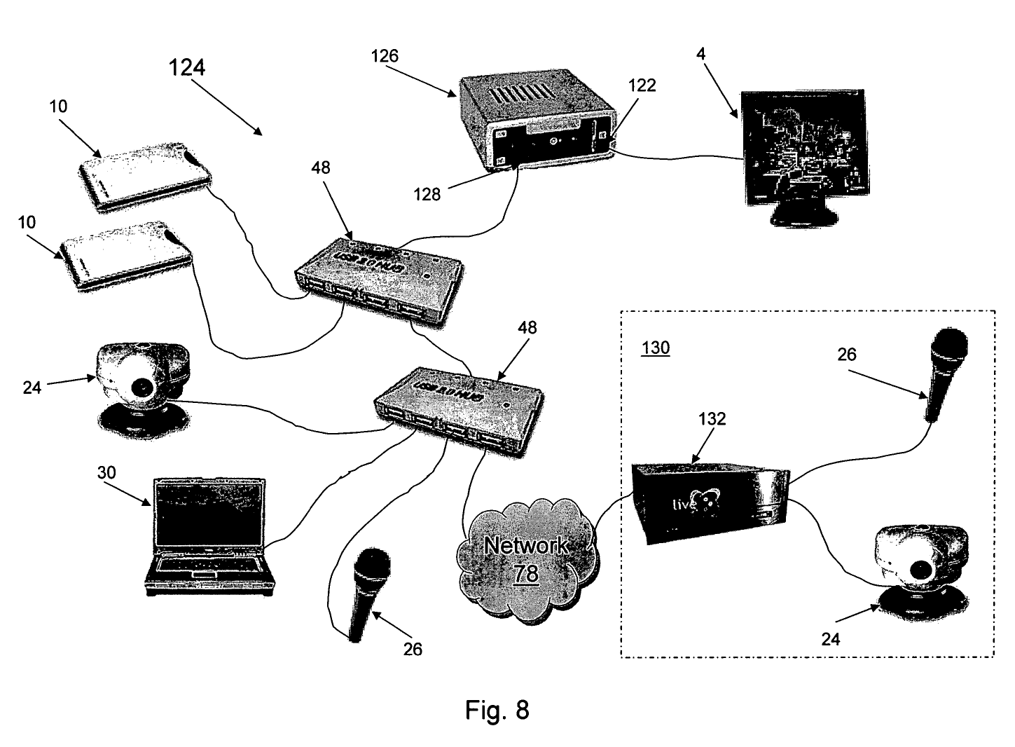

FIG. 8 illustrates a third example use case for a media recording system in accordance with the present invention. The media recording system 124 includes the video camera 24, the microphone 26, and the laptop 30 to capture media data and to generate media inputs from the captured media data locally. The media recording system 124 also includes a conferencing system 130. The conferencing system 130 may be a traditional video conferencing system such as those manufactured by Polycom, Inc. or Tandberg Data or a webconferencing system such as those manufactured by Webex Communications, Inc. The conferencing system 130 includes the microphone 26, the video camera 24, and a streaming media device 132. The output from the streaming media device 132 connects to a network 78 that connects to the USB hub 48 providing another media input.

The system 124 additionally includes USB hubs 48, a media recording device 126, two memories 10, and the display 4. The media devices 24, 26, 30, and 130 connect to one of the hubs 48 that is external to the media recording device 126. The memories 10 connect to the other hub 48. The two USB hubs 48 are daisy-chained together. The media recording device 126 connects to the hubs 48 at an input connector 128 integrated into media recording device 126 to receive media streams and to send media streams for recording on the memories 10. The input connector 128 may comprise a USB connector. Multiple input connectors 128 may be integrated into media recording device 126.

The media recording device includes the processor 6 and the media recording application 12 of FIG. 1. The memory 10 comprises a USB hard drive that connects to the media recording device 126 through the USB hub 48. The display 4 connects to the media recording device at a video connector 122 that may comprise a DVI-I connector.

The round-table meeting utilizing the media recording system 126 is a collaboration brain storming meeting between two geographically dispersed offices. A first meeting attendee has presentation materials stored on the laptop 30 at the first office location. A second meeting attendee has prepared transparencies with new product ideas that will be presented at the second office location. The transparencies are visible on display 4 through conferencing system 130 that is connected through network 78 to the media recording system 124. The video camera 24 at the second office location captures the transparencies presented at the second office location. The microphone 26 at the second office location captures the discussion among meeting attendees at the second office location. The media recording device 126 may record the media input from conferencing system 130. Two meeting attendees at the first office location brought memory devices 10 and plugged the respective memory devices into USB hub 48. At the completion of the meeting, each of the two meeting attendees removes their respective memory device 10 that contains the media streams recorded during the meeting. As a result, each memory device 10 contains a complete catalogue of the meeting including the material presented at the second office location.

As related previously, the media recording device 126 selects, encodes, and records media inputs generated by the media devices 24, 26, 30, and 130. At the completion of the meeting, the memory devices 10 may be removed from the media recording system 126. As a result, the meeting attendees can leave the meeting with a complete recording of the meeting content as presented from both office locations. The memory devices 10 may be connected to another compatible device including a PC connected to a network. The media streams may further be copied to other memories 10, e-mailed to others, made available using the Internet, etc. The media streams may then be replayed by others unable to attend the meeting or by meeting attendees for review of the meeting content.

It is understood that the invention is not confined to the particular embodiments set forth herein as illustrative, but embraces all such modifications, combinations, and permutations as come within the scope of the following claims. The functionality described may be implemented in a single module or may be distributed among modules that differ in number and distribution of functionality from those described herein without deviating from the spirit of the invention. Additionally, the order of execution of the functions may be changed without deviating from the spirit of the invention. Future technology advancements in the technology areas of media devices, connectors, connection devices, interfaces, memory devices, and displays in particular come within the scope of the following claims. Thus, the description of the exemplary embodiments is for purposes of illustration and not limitation.

1. A recording device comprising:
a connector, wherein the connector provides an interface to a media device and receives concurrent media inputs generated by the media device;
a memory;
a processor coupled to the memory that executes an application; and
the application comprising computer code configured to:
select three or more media inputs from the received concurrent media inputs to record to the memory;
encode any of the selected three or more media inputs to form a media stream if the selected media input is not in a media stream format; and
record the selected three or more media streams to the memory.

2. The device of claim 1, wherein the interface is selected from the group consisting of a Universal Serial Bus interface, a Small Computer System interface, an IEEE 1394 interface, a Digital Video interface, a Video Graphics Array interface, an IEEE 802.11 interface, a Bluetooth interface, an Ethernet interface, a telephone line interface, a coaxial cable interface, and an Integrated Device Electronics interface.

3. The device of claim 1, wherein the connector is selected from the group consisting of a Universal Serial Bus connector, a Small Computer System Interface connector, a IEEE 1394 connector, a Digital Video Interface connector, a Video Graphics Array connector, an IEEE 802.11 connector, a Bluetooth connector, an Ethernet connector, a telephone line connector, a coaxial cable connector, and an Integrated Device Electronics connector.

4. The device of claim 1, wherein the memory is selected from the group consisting of a flash memory, a compact disc, a digital video disc, a Jaz disc, a Zip disc, a floppy disk, and a hard disk.

5. The device of claim 1, wherein the media device is selected from the group consisting of a microphone, a video camera, a digital camera, a document camera, an electronic whiteboard, a personal computer, and a projector.

6. The device of claim 1, wherein the application further comprises computer code configured to enable at least one media device.

7. The device of claim 1, wherein the application further comprises computer code configured to synchronize and to index the selected three or more media streams before the selected three or more media streams are recorded to the memory.

8. The device of claim 1, wherein the application further comprises computer code configured to time stamp the selected three or more media streams before the selected three or more media streams are recorded to the memory.

9. The device of claim 1, wherein the application further comprises computer code configured to replay the recorded media streams.

10. The device of claim 1, further comprising a display.

11. The device of claim 1, further comprising a network connector.

12. A recording system comprising:
a media device, wherein the media device captures media data and generates concurrent media inputs from the captured media data;
an interface to each media device;
a connector, wherein the connector connects to the interface to each media device and receives the generated concurrent media inputs;
a memory;
a processor coupled to the memory that executes an application; and
the application comprising computer code configured to:
select three or more media inputs from the received concurrent media inputs to record to the memory;
encode any of the selected three or more media inputs to form a media stream if the selected media input is not in a media stream format; and
record the selected three or more media streams to the memory.

13. The system of claim 12, wherein the interface is selected from the group consisting of a Universal Serial Bus interface, a Small Computer System interface, an IEEE 1394 interface, a Digital Video interface, a Video Graphics Array interface, an IEEE 802.11 interface, a Bluetooth interface, an Ethernet interface, a telephone line interface, a coaxial cable interface, and an Integrated Device Electronics interface.

14. The system of claim 12, wherein the connector is selected from the group consisting of a Universal Serial Bus connector, a Small Computer System Interface connector, a IEEE 1394 connector, a Digital Video Interface connector, a Video Graphics Array connector, an IEEE 802.11 connector, a Bluetooth connector, an Ethernet connector, a telephone line connector, a coaxial cable connector, and an Integrated Device Electronics connector.

15. The system of claim 12, wherein the memory is selected from the group consisting of a flash memory, a compact disc, a digital video disc, a Jaz disc, a Zip disc, a floppy disk, and a hard disk.

16. The system of claim 12, wherein the media device is selected from the group consisting of a microphone, a video camera, a digital camera, a document camera, an electronic whiteboard, a personal computer, and a projector.

17. The system of claim 12, wherein the application further comprises computer code configured to enable at least one media device.

18. The system of claim 12, wherein the application further comprises computer code configured to synchronize and to index the selected three or more media streams before the selected three or more media streams are recorded to the memory.

19. The system of claim 12, wherein the application further comprises computer code configured to time stamp the selected three or more media streams before the selected three or more media streams are recorded to the memory.

20. The system of claim 12, wherein the application further comprises computer code configured to replay the recorded media streams.

21. The system of claim 12, further comprising a display.

22. The system of claim 12, further comprising a network connector.

23. The system of claim 12, further comprising an electronic payment system, wherein the electronic payment system validates access to the system and sends a validation signal to the processor if the access is validated.

24. A method of recording media data, the method comprising:
capturing media data by a media device connected to a connection device;
generating concurrent media inputs by the media device from the captured media data;
receiving the generated concurrent media inputs through the connection device at a recorder;
selecting three or more media inputs from the received concurrent media inputs using an application executing at the recorder;
encoding any of the selected three or more media inputs to form a media stream if the selected media input is not in a media stream format; and
recording the selected three or more media streams to a memory using the application.

25. The method of claim 24, further comprising enabling at least one media device from the recorder using the application.

26. The method of claim 24, further comprising synchronizing and indexing the selected three or more media streams at the recorder using the application before the selected three or more media streams are recorded to the memory.

27. The method of claim 24, further comprising time stamping the selected three or more media streams at the recorder using the application before the selected three or more media streams are recorded to the memory.

28. The method of claim 24, further comprising replaying the recorded media streams.

29. The method of claim 24, wherein the connection device comprises a connector and further wherein the connector is selected from the group consisting of a Universal Serial Bus connector, a Small Computer System Interface connector, a IEEE 1394 connector, a Digital Video Interface connector, a Video Graphics Array connector, an IEEE 802.11 connector, a Bluetooth connector, an Ethernet connector, a telephone line connector, a coaxial cable connector, and an Integrated Device Electronics connector.

30. The method of claim 24, wherein the memory is selected from the group consisting of a flash memory, a compact disc, a digital video disc, a Jaz disc, a Zip disc, a floppy disk, and a hard disk.

31. The method of claim 24, wherein the media device is selected from the group consisting of a microphone, a video camera, a digital camera, a document camera, an electronic whiteboard, a personal computer, and a projector.

32. The method of claim 24, further comprising:
validating user access to at least one media device using an electronic payment system connected to at least one connection device;
sending a validation signal from the electronic payment system to the recorder if the user access is validated;
receiving the validation signal at the recorder if the validation signal is sent; and
enabling at least one media device from the recorder if the validation signal is received.

33. A computer program product for recording media data comprising:
computer code configured to:
select three or more media inputs received from a media device to record to a memory;
encode any of the selected three or more media inputs to form a media stream if the selected media input is not in a media stream format; and
record the selected three or more media streams to the memory.

34. The computer program product of claim 33, wherein the memory is selected from the group consisting of a flash memory, a compact disc, a digital video disc, a Jaz disc, a Zip disc, a floppy disk, and a hard disk.

35. The computer program product of claim 33, wherein the media device is selected from the group consisting of a microphone, a video camera, a digital camera, a document camera, an electronic whiteboard, a personal computer, and a projector.

36. The computer program product of claim 33, wherein the computer code is further configured to enable at least one media device.

37. The computer program product of claim 36, wherein the at least one media device is enabled using an electronic payment system.

38. The computer program product of claim 33, wherein the computer code is further configured to synchronize and to index the selected three or more media streams before the selected three or more media streams are recorded to the memory.

39. The computer program product of claim 33, wherein the computer code is further configured to time stamp the selected three or more media streams before the selected three or more media streams are recorded to the memory.

40. The computer program product of claim 33, wherein the computer code is further configured to replay the recorded media streams.
